(19) United States
(12) Patent Application Publication
(10) Pub. No.: US 2017/0253717 A1
(43) Pub. Date: Sep. 7, 2017

(54) Conductive Thermoplastic Resin Composition

(71) Applicant: LOTTE ADVANCED MATERIALS CO., LTD., Yeosu-si (KR)

(72) Inventors: Chan Gyun SHIN, Uiwang-si (KR); Min Soo LEE, Uiwang-si (KR); Eun Hye JUNG, Uiwang-si (KR); Sang Hyun HONG, Uiwang-si (KR)

(73) Assignee: LOTTE ADVANCED MATERIALS CO., LTD., Yeosu-si (KR)

(21) Appl. No.: 15/505,326

(22) PCT Filed: Aug. 28, 2015
(86) PCT No.: PCT/KR2015/009094

§ 371 Date: Feb. 21, 2017

(30) Foreign Application Priority Data
Aug. 29, 2014 (KR) 10-2014-0114427
Aug. 27, 2015 (KR) 10-2015-0121274

(51) Int. Cl. C08K 3/04; C08K 7/06; H01B 1/04; C08K 7/14

(52) U.S. Cl. CPC C08K 3/041; C08K 7/14; C08K 7/06; H01B 1/04; C08K 2201/001; C08K 2201/011; B82Y 30/00

(57) ABSTRACT

A conductive thermoplastic resin composition, according to the present invention, comprises a polycarbonate resin and a conductive filler, wherein the conductive filler comprises carbon nanotube-modified glass fibers and/or processed carbon nanotube-modified glass fibers. A conductive thermoplastic resin composition has excellent electrical conductivity, flame retardancy, and mechanical properties.

### TECHNICAL FIELD

The present invention relates to a conductive thermoplastic resin composition. More particularly, the present invention relates to a conductive thermoplastic resin composition which has excellent electrical conductivity, flame retardancy, and mechanical properties, and a molded article including the same.

### BACKGROUND ART

Polycarbonate resins have excellent processability and moldability, and are widely applied to various household goods, office equipment, electric/electronic products, and the like. Many attempts have been made to use a polycarbonate resin for automobiles, various electric devices, electrical appliances such as TVs, electronic assemblies, and cables by imparting electric conductivity to the polycarbonate resin such that the polycarbonate resin can have electromagnetic shielding performance.

Specifically, electrostatic discharge can occur when a conductive panel and an exterior material formed of a polycarbonate resin or the like are jointed together, causing the conductive panel to be damaged due to sparks.

In order to prevent this problem, conventionally, there has been employed a method of protecting circuits by attaching a metallic conductive tape to an exterior material formed of a polycarbonate resin or the like or by coating a metal for grounding on one surface of the exterior material.

However, such a method of attaching a conductive tape or coating a metal has problems of high processing costs and difficulty in forming a thin film. Thus, there has been developed a conductive thermoplastic resin composition (material), which is obtained by mixing a thermoplastic resin such as polycarbonate resin with conductive fillers such as carbon black, carbon fiber, carbon nanotubes, metal powder, or metal-coated inorganic powder to impart electrical conductivity to the thermoplastic resin.

However, large amounts of conductive fillers are required to provide desired electrical conductivity to a conductive material. When large amounts of conductive fillers are used, impact strength and elongation of a molded article manufactured therefrom can be reduced, thereby causing deterioration in overall mechanical properties. In addition, since it is difficult to uniformly disperse the conductive fillers, the molded article can suffer from significant deterioration in flame retardancy and appearance, thereby making it difficult to use the molded article as an exterior material.

In order to overcome these problems, research has been conducted to improve dispersibility of conductive fillers. For example, there has been a method of adding an SAN resin to a polycarbonate resin to improve dispersibility of conductive fillers (bundle-type carbon nanotubes).

However, this method also has problems in that flame retardancy, mechanical strength, and appearance of the molded article can be reduced as the content of the SAN resin increases and it is difficult to secure good properties in terms of electrical conductivity, flame retardancy, mechanical properties, and appearance at the same time.

One example of the related art is disclosed in Korean Patent Laid-open Publication No. 10-2012-0078342.

### DISCLOSURE

### Technical Problem

It is one aspect of the present invention to provide a conductive thermoplastic resin composition which has excellent electrical conductivity, mechanical properties, flame retardancy, appearance, and balance therebetween.

It is another aspect of the present invention to provide a molded article manufactured using the conductive thermoplastic resin composition as set forth above.

The above and other objects of the present invention can be achieved by the present invention described below.

### Technical Solution

One aspect of the present invention relates to a conductive thermoplastic resin composition. The conductive thermoplastic resin composition includes: a polycarbonate resin; and conductive fillers, wherein the conductive fillers include carbon nanotube-modified glass fibers (CNT-modified glass fibers) or CNT-modified glass fiber workpieces.

In exemplary embodiments, the conductive fillers may be present in an amount of about 0.1 parts by weight to about 10 parts by weight relative to 100 parts by weight of the polycarbonate resin.

In exemplary embodiments, the CNT-modified glass fibers may be conductive fillers in which carbon nanotubes are cultivated on surfaces of glass fibers, and the CNT-modified glass fiber workpieces may be conductive fillers obtained by removing glass fibers from the CNT-modified glass fibers.

In exemplary embodiments, the CNT-modified glass fibers may have an average diameter of about 2 μm to about 20 μm and an average length of about 1 mm to about 10 mm.

In exemplary embodiments, the conductive thermoplastic resin may further include carbon fibers.

In exemplary embodiments, the carbon nanotubes may include at least one of single-walled carbon nanotubes (SWNTs), double-walled carbon nanotubes (DWNTs), and multi-walled carbon nanotubes (MWNTs).

Another aspect of the present invention relates to a molded article. The molded article is manufactured using the conductive thermoplastic resin composition as set forth above.

In exemplary embodiments, the molded article may have a surface resistance of about 10⁵ Ω·cm or less, as measured in accordance with ASTM D257.

In exemplary embodiments, the molded article may have a flame retardancy of V-0 or higher, as measured in accordance with UL94 and a notched Izod impact strength of about 4 kgf·cm/cm to about 10 kgf·cm/cm, as measured in accordance with ASTM D256.

In exemplary embodiments, the molded article may be an exterior material for electric/electronic products.

### Advantageous Effects

According to the present invention, it is possible to provide a conductive thermoplastic resin composition which has excellent electrical conductivity, mechanical properties, flame retardancy, appearance, and balance therebetween, and a molded article manufactured using the same.

### BEST MODE

Hereinafter, embodiments of the present invention will be described in detail.

It should be understood that the following embodiments are provided for complete disclosure and thorough understanding of the invention by those skilled in the art. In addition, unless otherwise stated, technical and scientific terms as used herein have a meaning generally understood by those skilled in the art. Descriptions of known functions and constructions which may unnecessarily obscure the subject matter of the present invention will be omitted.

A conductive thermoplastic resin composition according to the present invention includes (A) a polycarbonate resin; and (B) conductive fillers including at least one of (B1) carbon nanotube-modified glass fibers (CNT-modified glass fibers) and (B2) CNT-modified glass fiber workpieces.

(A) Polycarbonate Resin

The polycarbonate resin according to the present invention exhibits excellent mechanical properties in term of stiffness and impact strength, appearance, and moldability, and may include any polycarbonate resin prepared by a typical method without limitation. For example, aliphatic polycarbonate resins, aromatic polycarbonate resins, copolymer resins thereof, polyester carbonate resins, polycarbonate-polysiloxane copolymer resins, and combinations thereof may be used as the polycarbonate resin. Specifically, aromatic polycarbonate resins may be used as the polycarbonate resin.

In addition, the polycarbonate resin may be a linear polycarbonate resin, a branched polycarbonate resin, or a blend of linear and branched polycarbonate resins, without being limited thereto.

In some embodiments, the polycarbonate resin may be prepared by reacting (a1) an aromatic dihydroxy compound with (a2) a carbonate precursor.

(a1) Aromatic Dihydroxy Compound

The aromatic dihydroxy compound (a1) may be a compound represented by Formula 1 or a mixture thereof.

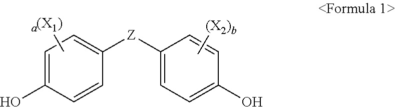

wherein X₁ and X₂ are each independently hydrogen, halogen, or a C₁ to C₈ alkyl group; a and b are each independently an integer of 0 to 4; and Z is a single bond, a C₁ to C₈ alkylene group, a C₂ to C₈ alkylidene group, a C₅ to C₁₅ cycloalkylene group, a C₅ to C₁₅ cycloalkylidene group, —S—, —SO—, SO₂—, —O—, or —CO—.

In some embodiments, examples of the aromatic dihydroxy compound represented by Formula 1 may include bis(hydroxyaryl)alkane, bis(hydroxyaryl)cycloalkane, bis(hydroxyaryl)ether, bis(hydroxyaryl)sulfide, bis (hydroxyaryl)sulfoxide, and biphenyl compounds. These may be used alone or as a mixture thereof.

Examples of the bis(hydroxyaryl)alkane may include bis(4-hydroxyphenyl)methane, bis(3-methyl-4-hydroxy phenyl)methane, bis (3-chloro-4-hydroxyphenyl)methane, bis(3,5 -dibromo-4-hydroxy phenyl)methane, 1,1-bis(4-hydroxyphenyl)ethane, 1,1-bis(2-tertiary-butyl-4-hydroxy-3-methylphenyl)ethane, 2-bis (4-hydroxyphenyl)propane (bisphenol A), 2,2-bis(3-methyl-4-hydroxyphenyl)propane, 2,2-bis(2-methyl-4-hydroxyphenyl)propane, 2,2-bis(3,5-dimethyl-4-hydroxyphenyl)propane, 1,1-bis(2-tertiary-butyl-4-hydroxy-5-methylphenyl)propane, 2,2-bis(3-chloro-4-hydroxyphenyl)propane, 2,2-bis (3-fluoro-4-hydroxyphenyl)propane, 2,2-bis(3-bromo-4-hydroxyphenyl)propane, 2,2-bis(3,5-difluoro-4-hydroxyphenyl)propane, 2,2-bis (3,5-dichloro-4-hydroxyphenyl)propane, 2,2-bis(3,5-dibromo-4-hydroxyphenyl)propane, 2,2-bis(4-hydroxyphenyl)butane, 2,2-bis(4-hydroxyphenyl)octane, 2,2-bis(4-hydroxyphenyl)phenylmethane, 2,2-bis(4-hydroxy-1-methylphenyl)propane, 1,1-bis(4-hydroxy-tertiary-butylphenyl)propane, 2,2-bis(4-hydroxy-3-bromophenyl)propane, 2,2-bis(4-hydroxy-3,5-dimethylphenyl)propane, 2,2-bis(4-hydroxy-3,5-dimethylphenyl)propane, 2,2-bis(4-hydroxy-3-chlorophenyl)propane, 2,2-bis (4-hydroxy -3,5-dichlorophenyl)propane, 2,2-bis(4-hydroxy-3,5 -dibromophenyl)propane, 2,2-bis(4-hydroxy-3,5-dibromophenyl)propane, 2,2-bis(3-bromo-4-hydroxy -5-chlorophenyl)propane, 2,2-bis (3-phenyl-4-hydroxyphenyl)propane, 2,2-bis(4-hydroxy phenyl)butane, 2,2-bis (3-methyl-4-hydroxyphenyl)butane, 1,1-bis (2-butyl-4-hydroxy -5-methylphenyl)butane, 1,1-bis(2-tertiary-butyl-4-hydroxy-5-methylphenyl)butane, 1,1-bis(2-tertiary-butyl-4-hydroxy-5-methylphenyl)butane, 1,1-bis (2-tertiary-amyl-4-hydroxy-5-methylphenyl)butane, 2,2-bis(3,5-dichloro-4-hydroxyphenyl)butane, 2,2-bis(3,5-dibromo-4-hydroxyphenyl)butane, 4,4-bis(4-hydroxyphenyl)heptane, 1,1-bis(2-tertiary-butyl-4-hydroxy-5-methylphenyl)heptane, 2,2-bis(4-hydroxyphenyl)octane, 1,1-(4-hydroxyphenyl)ethane, and combinations thereof, without being limited thereto.

Examples of the bis(hydroxyaryl)cycloalkane may include 1,1-bis(4-hydroxyphenyl)cyclopentane, 1,1-bis(4-hydroxyphenyl)cyclohexane, 1,1-bis(3-methyl-4-hydroxyphenyl)cyclohexane, 1,1-bis (3-cyclohexyl-4-hydroxyphenyl) cyclohexane, 1,1-bis (3-phenyl-4-hydroxyphenyl)cyclohexane, 1,1-bis (4-hydroxyphenyl)-3,5,5-trimethylcyclohexane, and combinations thereof, without being limited thereto.

Examples of the bis(hydroxy aryl)ether may include bis (4-hydroxyphenyl)ether, bis(4-hydroxy-3-methylphenyl)ether, and combinations thereof, without being limited thereto.

Examples of the bis(hydroxyaryl)sulfide may include bis(4-hydroxyphenyl)sulfide, bis(3-methyl-4-hydroxyphenyl)sulfide, and combinations thereof, without being limited thereto.

Examples of the bis(hydroxyaryl)sulfoxide may include bis(hydroxy phenyl)sulfoxide, bis(3-methyl-4-hydroxyphenyl)sulfoxide, bis (3-phenyl-4-hydroxyphenyl)sulfoxide, and combinations thereof, without being limited thereto.

Examples of the biphenyl compounds may include bis(hydroxyl aryl)sulfone, such as bis(4-hydroxyphenyl)sulfone, bis(3-methyl-4-hydroxyphenyl)sulfone, and bis(3-phenyl-4-hydroxyphenyl)sulfone, 4,4′-dihydroxybiphenyl, 4,4′-dihydroxy -2,2′-dimethylbiphenyl, 4,4′-dihydroxy -3,3′-dimethylbiphenyl, 4,4′-dihydroxy -3,3′-dicyclobiphenyl, 3,3-difluoro-4,4′-dihydroxybiphenyl, and combinations thereof, without being limited thereto.

In addition, examples of the aromatic dihydroxy compound (a1) other than the compound represented by Formula 1 may include dihydroxy benzene, halogen or alkyl-substituted dihydroxy benzene. For example, the aromatic dihydroxy compound (a1) other than the compound represented by Formula 1 may include resorcinol, 3-methylresorcinol, 3-ethylresorcinol, 3-propylresorcinol, 3-butylresorcinol, 3-tertiary-butylresorcinol, 3-phenylresorcinol, 2,3,4,6-tetrafluororesorcinol, 2,3,4,6-tetrabromoresorcinol, catechol, hydroquinone, 3-methylhydroquinone, 3-ethylhydroquinone, 3-propylhydroquinone, 3-butylhydroquinone, 3-tertiary-butylhydroquinone, 3-phenylhydroquinone, 3-cumylhydroquinone, 2,5-dichlorohydroquinone, 2,3,5,6-tetramethylhydroquinone, 2,3,5,6-tetra-tertiary-butylhydroquinone, 2,3,5,6-tetrafluorohydroquinone, 2,3,5,6-tetrabromohydroquinone, and combinations thereof, without being limited thereto.

In some embodiments, the aromatic dihydroxy compound (a1) is preferably 2,2-bis(4-hydroxyphenyl)propane (bisphenol A).

(a2) Carbonate Precursor

Examples of the carbonate precursor (a2) may include dimethyl carbonate, diethyl carbonate, dibutyl carbonate, dicyclohexyl carbonate, diphenyl carbonate, ditolyl carbonate, bis(chlorophenyl) carbonate, m-cresyl carbonate, dinaphthyl carbonate, bis(diphenyl) carbonate, carbonyl chloride (phosgene), triphosgene, diphosgene, carbonyl bromide, and bis-haloformate. These may be used alone or as a mixture thereof.

In some embodiments, a molar ratio of the carbonate precursor (a2) to the aromatic dihydroxy compound (a1) may range from about 0.9:1 to about 1.5:1.

In some embodiments, the polycarbonate resin may have a weight average molecular weight (Mw) of about 10,000 g/mol to about 200,000 g/mol, for example, about 15,000 g/mol to about 80,000 g/mol, as measured by gel permeation chromatography (GPC). Within this range, the conductive resin composition can have excellent properties in terms of processability and the like.

(B) Conductive Filler

The conductive fillers according to the present invention can be uniformly dispersed in the conductive thermoplastic resin composition, thereby improving electrical conductivity of the resin composition. Since electrical conductivity of the resin composition can be improved even using a small amount of the conductive fillers, it is possible to prevent or reduce deterioration in inherent mechanical properties, flame retardancy, and appearance characteristics of the resin composition due to an excess of conductive fillers. The conductive fillers include at least one of (B1) CNT-modified glass fibers and (B2) CNT-modified glass fiber workpieces.

In some embodiments, the CNT-modified glass fibers (B1) may have a structure in which carbon nanotubes (CNTs) are cultivated on surfaces of glass fibers. For example, the carbon nanotubes may be cultivated to form a network structure on the surfaces of the glass fibers.

As used herein, the term “cultivated” means that the carbon nanotubes are “bonded” to surfaces of glass fibers or “synthesized (formed) and grown” on surfaces of glass fibers. Here, bonding may include direct covalent bonding, ionic bonding, and physical adsorption by van der Waals forces. For example, the CNT-modified glass fibers may have a structure in which carbon nanotubes are directly covalently bonded to surfaces of glass fibers. Alternatively, the CNT-modified glass fibers may be obtained by barrier coating of carbon nanotubes on surfaces of glass fibers, or by an indirect method in which carbon nanotubes are synthesized and grown in the presence of a catalyst for forming carbon nanotubes.

The CNT-modified glass fibers according to the present invention may be prepared by (a) forming a catalyst for forming carbon nanotubes on surfaces of glass fibers and (b) synthesizing and growing carbon nanotubes on the surfaces of the glass fibers.

The glass fibers used in step (a) may be glass fibers without any treatment or glass fibers subjected to surface-modification. Here, the surface-modification is intended to improve interfacial interaction of carbon nanotubes and may be performed by any typical coating method such as dip coating or spray coating. Alternatively, the glass fibers may be surface-modified using a silane coupling agent, without being limited thereto.

The catalyst for forming carbon nanotubes used in step (a) may be any catalyst well known in the art without limitation. For example, transition metal nanoparticles may be used as the catalyst. Examples of the transition metal may include: one or more transition metal elements selected from among scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, indium, platinum and gold; alloys thereof; and salts of basic transition metal elements.

In step (b), the carbon nanotubes may be formed from a carbon source in the presence of the catalyst for forming carbon nanotubes, such as the transition metal nanoparticles, formed on the surfaces of the glass fibers, followed by depositing a carbon source on the formed carbon nanotubes through chemical vapor deposition (CVD), plasma-enhanced chemical vapor deposition (PECVD), or the like, thereby growing the carbon nanotubes. Here, the structure of the carbon nanotubes can be controlled by varying the flow rate, reaction temperature and residence time of the carbon source.

In some embodiments, the CNT-modified glass fibers may have a network structure in which neighboring carbon nanotubes are highly intertwined, and the carbon nanotubes grown on the surfaces of the glass fibers may be uniform in length.

In some embodiments, the carbon nanotubes (CNTs) may include any carbon nanotubes well known in the art without limitation. For example, the carbon nanotubes may include single-walled carbon nanotubes (SWNTs), double-walled carbon nanotubes (DWNTs), multi-walled carbon nanotubes (MWNTs), rope carbon nanotubes, and combinations thereof Specifically, the carbon nanotubes may include single-walled carbon nanotubes (SWNTs), double-walled carbon nanotubes (DWNTs), multi-walled carbon nanotubes (MWNTs), or combinations thereof. Particularly, relatively inexpensive and highly pure multi-walled carbon nanotubes (MWNTs) may be bonded to the surfaces of the glass fibers or may be synthesized (formed) and grown on the surfaces of the glass fibers to be used as the carbon nanotubes.

In some embodiments, the CNT-modified glass fibers may have an average diameter of about 2 μm to about 20 μm, for example about 10 μm to about 15 μm, and an average length of about 1 mm to about 10 mm, for example, about 2.5 mm to about 5 mm and the cultivated carbon nanotubes may have an average diameter of about 1 nm to about 50 nm, for example, about 2 nm to about 10 nm, and an average length of about 10 μm to about 200 μm, for example, about 100 μm to about 150 μm. Within this range, the conductive fillers can be uniformly dispersed in the conductive thermoplastic resin composition and can considerably improve electrical conductivity of the resin composition even when used in a small quantity.

In some embodiments, a weight ratio of the glass fibers to the cultivated carbon nanotubes (glass fibers:carbon nanotubes) may range from 1:0.05 to 1:0.3, for example 1:0.08 to 1:0.15. Within this range, the conductive fillers can be uniformly dispersed in the conductive thermoplastic resin composition and can considerably improve electrical conductivity of the resin composition even when used in a small quantity.

In some embodiments, the CNT-modified glass fiber workpieces (B2) may be obtained by removing at least 90% of glass fibers from the CNT-modified glass fibers (B1) through pulverization or the like. Pulverization and removal of the glass fibers may be performed by any pulverization method well known in the art. The CNT-modified glass fiber workpieces are conductive fillers in the form of flakes aligned in a certain direction and thus can have excellent dispersibility, thereby realizing excellent appearance, as compared with typical carbon nanotubes.

In some embodiments, the conductive fillers may be present in an amount of about 0.1 parts by weight to about 10 parts by weight, for example, about 1 part by weight to about 7 parts by weight relative to 100 parts by weight of the polycarbonate resin. Within this range, it is possible to obtain a conductive thermoplastic resin composition which has considerably improved electrical conductivity, mechanical properties, flame retardancy, and appearance, as compared with a conductive thermoplastic resin composition including typical conductive fillers.

The conductive thermoplastic resin composition according to the present invention may further include carbon fibers. The carbon fibers can further improve electrical conductivity, mechanical properties, and dimensional stability of the conductive thermoplastic resin composition and may include any carbon fibers well known in the art. For example, the carbon fibers may be carbon-based or graphite-based carbon fibers and may have an average particle diameter of about 5 μm to about 15 μm and an average length of about 100 μm to about 900 μm, without being limited thereto.

In some embodiments, apart from the conductive fillers, the carbon fibers may be optionally present in an amount of about 2 parts by weight to about 30 parts by weight, for example, about 4 parts by weight to about 20 parts by weight, relative to 100 parts by weight of the polycarbonate resin. Within this range, the conductive thermoplastic resin composition can be further improved in electrical conductivity, mechanical properties, dimensional stability, and balance therebetween.

The conductive thermoplastic resin composition according to the present invention may further include various additives without altering the effects of the present invention, as needed. For example, the conductive thermoplastic resin composition may further include inorganic fillers, antioxidants, releasing agents, flame retardants, lubricants, colorants, functional additives, thermoplastic elastomers, and combinations thereof, without being limited thereto.

The conductive thermoplastic resin composition according to the present invention may be prepared by any suitable known method. For example, the conductive thermoplastic resin composition may be prepared through a process in which the above components are mixed using a Henschel mixer, a V blender, a tumbler blender, or a ribbon blender, followed by melting, kneading and extrusion in a single screw extruder or a twin screw extruder at a temperature of about 150° C. to about 300° C.

In accordance with another aspect of the present invention, a molded article is manufactured using the conductive thermoplastic resin composition as set forth above. For example, the molded article may be manufactured using the conductive thermoplastic resin composition by any molding method known in the art, such as injection molding, extrusion, and blow molding. The molded article can be easily manufactured by a person having ordinary skill in the art to which the present invention pertains.

In some embodiments, the molded article (or the conductive thermoplastic resin composition) may have a surface resistance of about 10⁵ Ω·cm or less, for example, 10² Ω·cm to about 10⁵ Ω·cm, as measured in accordance with ASTM D257, a flame retardancy of V-0 or higher, as measured in accordance with UL94, and a notched Izod impact strength of about 4 kgf·cm/cm to about 10 kgf·cm/cm, for example, about 4.5 kgf·cm/cm to about 8.5 kgf·cm/cm, as measured in accordance with ASTM D256.

The molded article according to the present invention is excellent in electrical conductivity, flame retardancy, and mechanical properties such as impact resistance and thus can be applied to exterior materials for electric/electronic products such as TVs.

### Mode for Invention

Hereinafter, the present invention will be described in more detail with reference to some examples. It should be understood that these examples are provided for illustration only and are not to be construed in any way as limiting the present invention.

### EXAMPLE

Details of components used in the following Examples and Comparative Examples are as follows:

(A) Polycarbonate Resin

INFINO SC-1190 (Samsung SDI Co., Ltd., melt-flow index (300° C., 1.2 kg): 20 g/10 min, weight average molecular weight (Mw): 24,000 g/mol)

(B) Conductive Fillers

(B1) CNT-Modified Glass Fibers

CNT-modified glass fibers (ANS Co. Ltd., average diameter of glass fibers: 13 μm, average length of glass fibers: 3 mm, average diameter of cultivated carbon nanotubes: 10 nm, average length of 10 μm, weight ratio of glass fibers to carbon nanotubes: 1:0.12)

(B2) CNT-Modified Glass Fiber Workpieces

PU post coated CNS (ANS Co. Ltd., average diameter: 10 nm, average length: 10 μm)

(C) Carbon Fibers

PX35 (Zoltek)

(D) Carbon Nanotubes

CM-130 (Hanwha Chemical)

(E) Carbon Black

ENSACO® 150 (Timcal SA)

(F) Ketchen Black

EC-300J (Akzo Nobel Polymer Chemicals)

### Examples 1 to 6

### Preparation of Conductive Thermoplastic Resin Composition

As additives, 20 parts by weight of glass fibers (183F, Owens Corning Corp., average length: 3 mm), 0.5 parts by weight of HDPE wax (HI-WAX 400P, MITSUI PETROCHEMICAL), and 0.5 parts by weight of an antioxidant (Doverphos S-9228 PC, DOVER CHEMICAL) were mixed with 100 parts by weight of a polycarbonate resin (A), followed by dry blending, thereby preparing a polycarbonate resin composition. Then, the prepared polycarbonate resin composition, conductive fillers (B), and carbon fibers (C) were placed in amounts as listed in Table 1 in a twin screw extruder with a side feeder (φ=45 mm), followed by processing at a nozzle temperature of 250° C. to 280° C., thereby preparing a conductive thermoplastic resin composition in pellet form. Here, the conductive fillers (B) and carbon fibers (C) were introduced through the side feeder. The prepared pellets were dried at 100° C. for 3 hours, followed by injection molding, thereby preparing a specimen for property evaluation. Each of the prepared specimens was evaluated as to the following properties. Results are shown in Table 2.

### Comparative Examples 1 to 7

### Preparation of Conductive Thermoplastic Resin Composition

A conductive thermoplastic resin composition was prepared in the same manner as in Example 1 except that carbon nanotubes (D), carbon black (E), or Ketjen black (F) was used in an amount listed in Table 1 instead of the conductive fillers (B). The prepared pellets were dried at 100° C. for 3 hours, followed by injection molding, thereby preparing a specimen for property evaluation. Each of the prepared specimens was evaluated as to the following properties. Results are shown in Table 2.

TABLE 1

| | | (B) | | | | | |
|---|---|---|---|---|---|---|---|
| | (A) | (B1) | (B2) | (C) | (D) | (E) | (F) |
| Example 1 | 100 | 3 | — | — | — | — | — |
| Example 2 | 100 | 5 | — | — | — | — | — |
| Example 3 | 100 | — | 1 | — | — | — | — |
| Example 4 | 100 | — | 2 | — | — | — | — |
| Example 5 | 100 | 3 | — | 5 | — | — | — |
| Example 6 | 100 | — | 1 | 15 | — | — | — |
| Comparative | 100 | — | — | — | 1 | — | — |
| Example 1 | | | | | | | |
| Comparative | 100 | — | — | — | 3 | — | — |
| Example 2 | | | | | | | |
| Comparative | 100 | — | — | — | 5 | — | — |
| Example 3 | | | | | | | |
| Comparative | 100 | — | — | — | — | 5 | — |
| Example 4 | | | | | | | |
| Comparative | 100 | — | — | — | — | 10 | — |
| Example 5 | | | | | | | |
| Comparative | 100 | — | — | — | — | — | 5 |
| Example 6 | | | | | | | |
| Comparative | 100 | — | — | — | | — | 10 |
| Example 7 | | | | | | | |

(Unit: parts by weight)

Property Evaluation

(1) Surface Resistance (unit: Ω·cm)

Surface resistance of each of the specimens was measured using a surface resistance meter (SRM-100, Wolfgang Warmbier GmbH & Co. KG.) in accordance with ASTM D257.

(2) Notched Izod Impact Strength (unit: kgf·cm/cm)

Notched Izod impact strength was measured on a ⅛″ thick notched Izod specimen in accordance with ASTM D256.

(3) Flame Retardancy

Flame retardancy was measured on a 3 mm thick specimen in accordance with UL 94.

(4) Surface Roughness (unit: nm)

Surface roughness (Ra) of each of the specimens was measured using a surface profiler (Dektak 150, Veeco Instruments).

TABLE 2

| | Surface | Flame | | Surface |
|---|---|---|---|---|
| | resistance | retardancy | IZOD impact | roughness |
| | (Ω · cm) | (UL94) | strength (kgf · cm/cm) | (nm) |
| Example 1 | 10⁵ | V-0 | 6.1 | 0.1 |
| Example 2 | 10⁴ | V-0 | 5.8 | 0.2 |
| Example 3 | 10⁴ | V-0 | 5.7 | 0.2 |
| Example 4 | 10² | V-0 | 5.2 | 0.4 |
| Example 5 | 10⁴ | V-0 | 5.9 | 0.4 |
| Example 6 | 10² | V-0 | 4.8 | 0.4 |
| Comparative | 10¹¹ | V-1 | 7.0 | 0.3 |
| Example 1 | | | | |
| Comparative | 10⁷ | V-1 | 5.2 | 1.0 |
| Example 2 | | | | |
| Comparative | 10⁴ | Fail | 3.7 | 2.8 |
| Example 3 | | | | |
| Comparative | 10¹¹ | Fail | 4.6 | 0.4 |
| Example 4 | | | | |
| Comparative | 10⁶ | Fail | 3.1 | 1.4 |
| Example 5 | | | | |
| Comparative | 10⁷ | Fail | 4.1 | 1.4 |
| Example 6 | | | | |
| Comparative | 10⁴ | Fail | 3.5 | 2.9 |
| Example 7 | | | | |

From the results shown in Table 2, it can be seen that the conductive thermoplastic resin composition according to the present invention (Examples 1 to 6) had improved electric conductivity and flame retardancy despite the use of a small amount of the conductive fillers (B) (5 parts by weight or less relative to 100 parts by weight of the polycarbonate resin (A)).

Particularly, from the results of Examples 5 and 6, it can be seen that, when the carbon fibers (C) were further added to the conductive thermoplastic resin composition, the resin composition had improved electrical conductivity and processability and exhibited excellent balance between flame retardancy, mechanical properties, and appearance.

Conversely, it can be seen that, when the carbon nanotubes (D) were used instead of the conductive fillers (B) according to the present invention as in Comparative Examples 1 to 3, the content of the carbon nanotubes in the resin was substantially increased, but the resin compositions exhibited insignificant improvement in electrical conductivity, as compared with the increase in content of the carbon nanotubes, and when the carbon nanotubes were used in an amount of 5 parts by weight or more, the resin composition exhibited deterioration in flame retardancy, mechanical properties and appearance. In addition, it can be seen that when carbon black (E) or Ketjen black (F) was used as the conductive fillers as in Comparative Examples 4 and 6, the content of conductive fillers was insufficient despite the addition of 5 parts by weight of the carbon black or the Ketjen black, and electrical conductivity and flame retardancy of the resin composition were deteriorated. Further, it can be seen that when conductive fillers (carbon black (E) or Ketjen black (F)) were used in an amount of 10 parts by weight, as in Comparative Example 5 and 7, the resin composition exhibited deterioration in terms of mechanical properties, flame retardancy and appearance, despite improvement in electrical conductivity. Thus, it can be seen that the conductive thermoplastic resin compositions of Comparative Examples 1 to 7 were not suitable for mass production due to poor balance between physical properties.

As such, the conductive thermoplastic resin composition according to the present invention is prepared by adding the conductive fillers including at least one of the CNT-modified glass fibers and the CNT-modified glass fiber workpieces to the polycarbonate resin in an optimal amount in order to improve dispersibility of the conductive fillers in the thermoplastic resin, and thus has improved properties not only in terms of electrical conductivity and flame retardancy, but also in terms of mechanical properties and appearance. Therefore, the conductive thermoplastic resin composition according to the present invention is suitable for use as an exterior material for electric/electronic products such as TVs.

Although some embodiments have been described herein, it should be understood by those skilled in the art that these embodiments are given by way of illustration only and the present invention is not limited thereto. In addition, it should be understood that various modifications, variations, and alterations can be made by those skilled in the art without departing from the spirit and scope of the present invention. Therefore, the scope of the invention should be limited only by the accompanying claims and equivalents thereof.

1. A conductive thermoplastic resin composition, comprising: a polycarbonate resin; and conductive fillers, wherein the conductive fillers comprise at least one of CNT-modified glass fibers and CNT-modified glass fiber workpieces.

2. The conductive thermoplastic resin composition according to claim 1, wherein the conductive fillers are present in an amount of about 0.1 parts by weight to about 10 parts by weight relative to 100 parts by weight of the polycarbonate resin.

3. The conductive thermoplastic resin composition according to claim 1, wherein the CNT-modified glass fibers are conductive fillers in which carbon nanotubes are cultivated on surfaces of glass fibers, and the CNT-modified glass fiber workpieces are conductive fillers obtained by removing glass fibers from the CNT-modified glass fibers.

4. The conductive thermoplastic resin composition according to claim 1, wherein the CNT-modified glass fibers have an average diameter of about 2 μm to about 20 μm and an average length of about 1 mm to about 10 mm.

5. The conductive thermoplastic resin composition according to claim 1, wherein the conductive fillers further comprise carbon fibers.

6. The conductive thermoplastic resin composition according to claim 1, wherein the carbon nanotubes comprise at least one of single-walled carbon nanotubes (SWNTs), double-walled carbon nanotubes (DWNTs), and multi-walled carbon nanotubes (MWNTs).

7. A molded article manufactured using the conductive thermoplastic resin composition according to claim 1.

8. The molded article according to claim 7, wherein the molded article has a surface resistance of about 10⁵ Ω·cm or less, as measured in accordance with ASTM D257

9. The molded article according to claim 7, wherein the molded article has a flame retardancy of V-0 or higher, as measured in accordance with UL94 and a notched Izod impact strength of about 4 kgf·cm/cm to about 10 kgf·cm/cm, as measured in accordance with ASTM D256.

10. The molded article according to claim 7, wherein the molded article is an exterior material for electric/electronic products.

11. The conductive thermoplastic resin composition according to claim 3, wherein the conductive fillers comprise the CNT-modified glass fibers.

12. The conductive thermoplastic resin composition according to claim 3, wherein the conductive fillers comprise the CNT-modified glass fiber workpieces.
